(19) United States
(12) Patent Application Publication
(10) Pub. No.: US 2016/0370728 A1
(43) Pub. Date: Dec. 22, 2016

(54) IMAGE FORMING APPARATUS AND PROGRAM

(71) Applicants: Akinori YAMAGUCHI, Osaka (JP); Masayuki HAYASHI, Osaka (JP); Motohiro KAWANABE, Osaka (JP); Yoshinori SHIRASAKI, Osaka (JP); Yuusuke KOHRI, Osaka (JP); Masatoshi MURAKAMI, Osaka (JP)

(72) Inventors: Akinori YAMAGUCHI, Osaka (JP); Masayuki HAYASHI, Osaka (JP); Motohiro KAWANABE, Osaka (JP); Yoshinori SHIRASAKI, Osaka (JP); Yuusuke KOHRI, Osaka (JP); Masatoshi MURAKAMI, Osaka (JP)

(73) Assignee: Ricoh Company, Ltd., Tokyo (JP)

(21) Appl. No.: 15/182,745

(22) Filed: Jun. 15, 2016

(30) Foreign Application Priority Data
Jun. 18, 2015 (JP) 2015-123235

(51) Int. Cl. B41J 2/385

(52) U.S. Cl. CPC G03G 15/043

(57) ABSTRACT

There is provided an image forming apparatus for forming a latent image on a photoconductor by causing a plurality of light emitting bodies to emit light, the image forming apparatus comprising: a storage unit configured to store respective performances of the light emitting bodies; a control unit configured to control the light emitting bodies to emit the light; wherein the control unit adjusts light emitting periods of the light emitting bodies based on the performances of the light emitting bodies so that a capability of one light emitting body of the light emitting bodies for forming the latent image becomes closer to a capability of another light emitting body of the light emitting bodies for forming the latent image.

### BACKGROUND OF THE INVENTION

1. Field of the Invention

The present disclosure relates to image forming apparatuses and programs.

2. Description of the Related Art

In the image scanning method using, such as LED (light-emitting diode) head, light emitting elements included in the head are not illuminated at the same time. Instead, their illuminating timings are shifted, where the light-emitting elements are divided into a plurality of groups.

When the light timings of the light-emitting elements are shifted, a maximum power for emitting light can be reduced.

In the above described method, the image forming apparatus controls respective illuminating timing of the light-emitting elements divided into a plurality of groups on a group-by-group basis to emit the light onto photoconductor.

The LED elements and organic EL elements used in the light emitting elements constituting the image scanning head have discrete luminescence characteristics on element-by element basis. Therefore, amount of energy received by the photoconductor varies even if the light emitting elements illuminate the same period. Accordingly, unevenness of image intensity is caused.

A correction method for making light intensities even is known (e.g., Patent Document 1). However, it is difficult to prevent the unevenness because of difficulty in reducing difference of the light intensities to make them even.

### RELATED ART DOCUMENT

### Patent Document

### [Patent Document 1]: Japanese Unexamined Patent Application Publication No. 2010-179555

### SUMMARY OF THE INVENTION

An object of the present disclosure is to reduce difference of energy amounts received by photoconductor through an illuminating process of light emitting bodies, thereby reducing unevenness of the image intensity.

The following configuration is adopted to achieve the aforementioned object.

In one aspect of the embodiment of the invention, there is provided an image forming apparatus for forming a latent image on a photoconductor by causing a plurality of light emitting bodies to emit light, the image forming apparatus comprising: a storage unit configured to store respective performances of the light emitting bodies; a control unit configured to control the light emitting bodies to emit the light; wherein the control unit adjusts light emitting periods of the light emitting bodies based on the performances of the light emitting bodies so that a capability of one light emitting body of the light emitting bodies for forming the latent image becomes closer to a capability of another light emitting body of the light emitting bodies for forming the latent image.

Other objects, features and advantages of the present invention will become apparent from the following detailed description when read in conjunction with the accompanying drawings.

### BRIEF DESCRIPTION OF THE DRAWINGS

FIG. 1 is a diagram illustrating a general arrangement of an image forming apparatus.

FIG. 2 is a diagram illustrating the image forming apparatus of the first embodiment.

FIG. 3 is a diagram illustrating an example hardware configuration of the image forming apparatus.

FIG. 4 is a diagram illustrating a functional configuration of the image forming apparatus.

FIG. 5 is a diagram illustrating an example configuration of an image scanning head.

FIG. 6 is a diagram illustrating an example illuminating process of the image scanning head emitting the light to the photoconductor drum.

FIG. 7 is a diagram illustrating an example light intensities of light emitting elements, where the respective light emitting elements are operated with a predetermined electric power.

FIG. 8 is a diagram illustrating example luminescence energies corresponding to the respective light emitting elements.

FIG. 9 is a diagram illustrating example average light intensities of respective groups of the light emitting elements.

FIG. 10 is a diagram illustrating a relationship between light intensities, strobe periods and luminescence energies of the light emitting elements.

FIG. 11 is a timing diagram illustrating an example timing control of the present embodiment.

FIG. 12 is a diagram illustrating information related to light emitting periods of the present embodiment.

FIG. 13 is a timing diagram illustrating an example timing control of the present embodiment.

FIG. 14 is a timing diagram illustrating an example timing control of the present embodiment.

FIG. 15 is a diagram illustrating example information related to the light emitting periods.

FIG. 16 is a diagram illustrating an example illuminating process of the image scanning head emitting the light to the photoconductor drum of the second embodiment.

FIG. 17 is a diagram illustrating an example relationship between a spot area and a strobe period before the adjustment.

FIG. 18 is a diagram illustrating an example relationship between the spot area and the strobe period after the adjustment.

FIG. 19 is a diagram illustrating an example illuminating process of the image scanning head emitting the light to the photoconductor drum of the third embodiment.

### DETAILED DESCRIPTION OF THE PREFERRED EMBODIMENTS

### First Embodiment

In the following, a first embodiment will be described with reference to accompanying drawings.

<General Arrangement of Image Forming Apparatus>

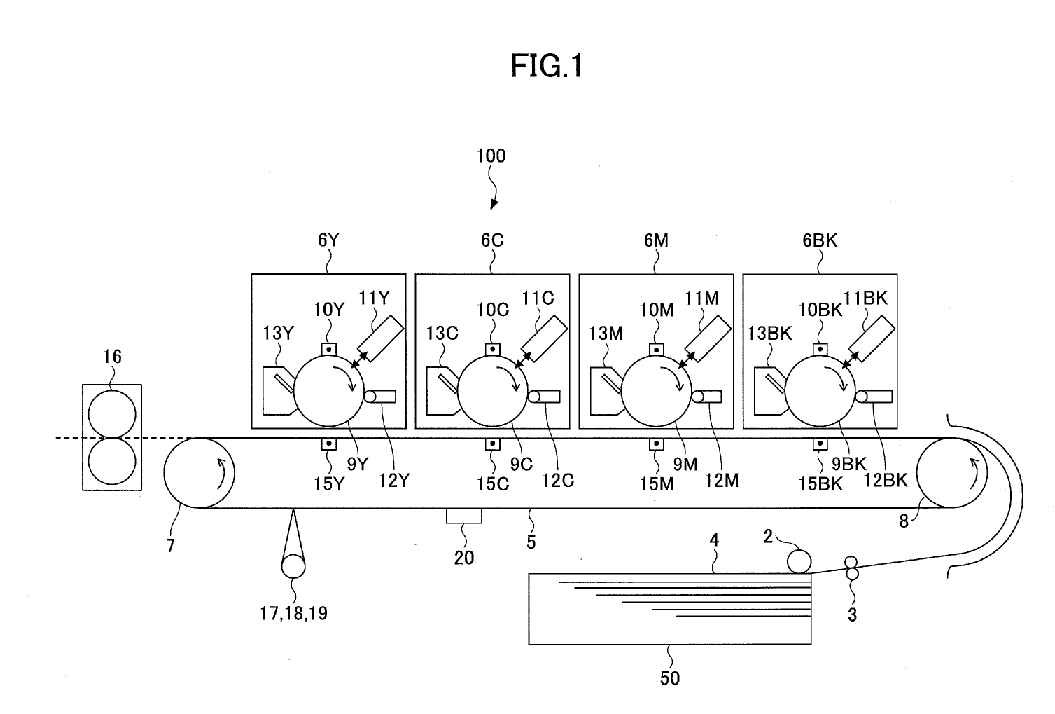

FIG. 1 is a diagram illustrating a general arrangement of an image forming apparatus 100 of the present embodiment.

The image forming apparatus 100 includes a paper feeding tray 50, a paper feeding roller 2, a separation roller 3, a conveyance belt 5, an image forming unit, a drive roller 7, a driven roller 8, a transfer device 15, a fixing device 16, a pattern detection sensor 17 and a belt cleaner 20.

The conveyance belt 5 is an endless conveyance part. The conveyance belt 5 is wounded around the drive roller 7 and the driven roller 8 that are driven to be rotated. The drive roller 7 is driven and rotated by a drive motor (not shown). The drive roller 7 and the driven roller 8 move the conveyance belt 5.

The paper feeding tray 50 stores sheets 4. The sheets 4 are separated one by one through the paper feed roller 2 and the separation roller 3, and conveyed from upstream side to downstream side in a conveyance direction by the conveyance belt 5. The sheet 4 is attracted by the conveyance belt 5 due to electrostatic attraction.

From the upstream side to downstream side of the conveyance direction, an image forming unit 6BK for black, an image forming unit 6M for magenta, an image forming unit 6C for cyan and image forming unit 6Y for yellow are arranged in the order. The image forming units 6 form discrete colored toner images, while internal configurations thereof are the same.

The sheet 4 is conveyed into the image forming unit 6BK and a black colored toner image is transferred onto the sheet 4. Similarly, a magenta colored toner image, a cyan colored toner image and a yellow colored toner image are respectively transferred onto the sheet 4.

The image forming unit 6BK includes a photoconductor drum 9BK, a charging device 10BK, an image scanning head 11BK, a development device 12BK, a photoconductor cleaner (hot shown) and a discharging device 13BK, and the like.

The photoconductor drum 9BK is a photoconductor for transferring the toner to the sheet 4. The charging device 10BK, the image scanning head 11BK, a development device 12BK, a photoconductor cleaner (hot shown) and a discharging device 13BK, etc., are arranged around the photoconductor drum 9BK.

The charging device 10BK uniformly charges an outer peripheral surface of the photoconductor drum 9BK.

The image scanning head 11BK includes a plurality of LEDs, a plurality of organic ELs, etc., as a light emitting element 500. The image scanning head 11BK emits the light corresponding to a black image, thereby forming a latent image of the black image on the photoconductor drum 9BK.

The development device 12BK makes the latent image of the black image formed on the photoconductor drum 9BK be a visible image by using black toner. That is, the development device 12BK forms a black colored toner image on the photoconductor drum 9BK.

The transfer device 15BK transfers the black colored toner image onto the sheet 4 conveyed on the conveyance belt 5 at a transfer position where the photoconductor drum 9BK abuts on the sheet 4.

The photoconductor cleaner removes unnecessary toner remained on the outer peripheral surface of the photoconductor drum 9BK.

The discharging device 13BK discharges the photoconductor drum 9BK.

After the transfer of the black colored toner image, the sheet 4 is conveyed into the next image forming unit 6M by the conveyance belt 5.

Similarly to the image forming unit 6BK, the image forming unit 6M forms the magenta colored toner image on the photoconductor drum 9M, and transfers the magenta colored toner image onto the sheet 4, which toner image is super imposed.

Similarly, the image forming unit 6C and the image forming unit 6Y respectively transfer the cyan colored toner image and the yellow colored toner image onto the sheet 4.

Additionally, respective configurations of the image forming unit 6M, the image forming unit 6C and the image forming unit 6Y are the same as that of the image forming unit 6BK.

When toner images corresponding to four colors are transferred onto the sheet 4, a full-color image is formed on the sheet 4.

The sheet 4 on which the full-color image is formed is separated from the conveyance belt 5 to be sent into the fixing device 16. The fixing device 16 ejects the sheet 4 outside the image forming apparatus 100 after fixing the full-color image thereon.

The image forming apparatus 100 may include a pattern detection sensor 17. The pattern detection sensor 17 is an optical sensor for reading a positional deviation correction pattern and an intensity correction pattern that are transferred onto the conveyance belt 5 by the photoconductor drums 9BK, 9M, 9C and 9Y.

The pattern detection sensor 17 includes a light emitting element 500 for irradiating the pattern depicted on the surface of the conveyance belt 5 and a light receiving element for receiving light reflected at the correction patterns.

The belt cleaner 20 is disposed downstream of the pattern detection sensor 17 and upstream of the photoconductor drum 9. The belt cleaner 20 removes the toner adhered on the surface of the conveyance belt 5.

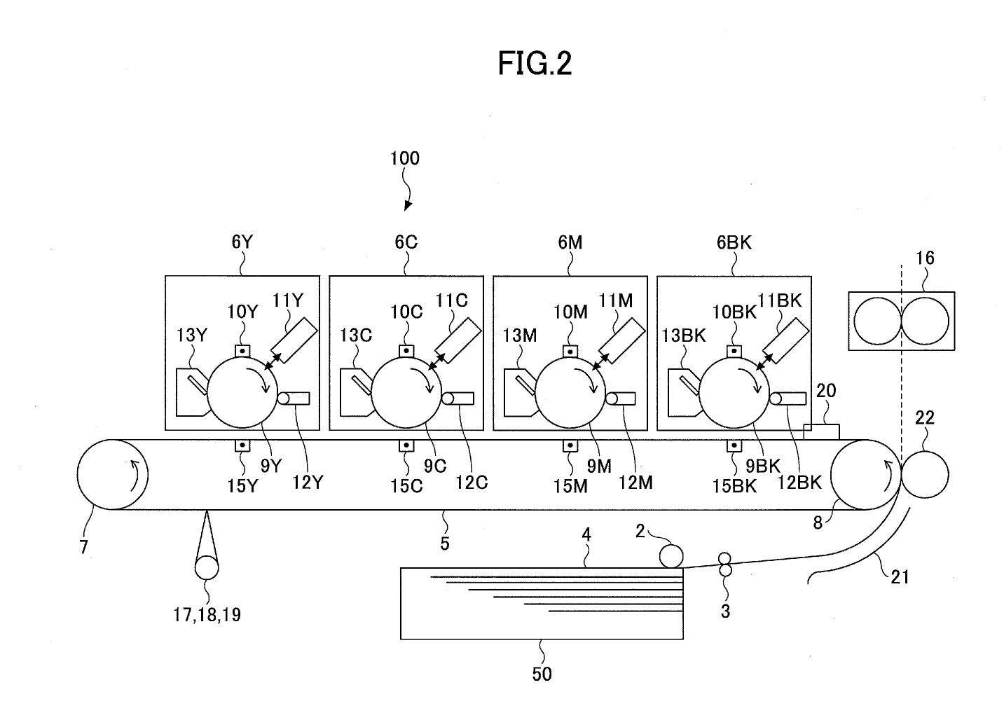

FIG. 2 is a diagram illustrating the image forming apparatus 100 of the first embodiment.

Descriptions of parts or units common to FIG. 1 are omitted, while differences between FIG. 2 and FIG. 1 are described.

The image forming apparatus 100 includes the paper feeding tray 50, the paper feeding roller 2, the separation roller 3, the intermediate transfer belt 30, an image forming unit 6, the drive roller 7, the driven roller 8, the transfer device 15, the fixing device 16, the pattern detection sensor 17, the belt cleaner 20 and a secondary transfer roller 22.

The image forming apparatus 100 shown in FIG. 2 includes an intermediate transfer belt 30 as the endless conveyance part instead of the conveyance belt 5.

The image forming units 6 corresponding to the respective colors form toner images on the photoconductor drums 9 corresponding to respective colors.

The transfer devices 15 provided for respective colors transfer toner images corresponding to respective colors onto the intermediate transfer belt 30. The full-color image is formed on the intermediate transfer belt 30 through the transfer.

The full-color image formed on the intermediate transfer belt 30 is transferred onto the sheet 4 at a secondary transfer position 21.

The secondary transfer roller is disposed downstream of the secondary transfer position 21. The secondary transfer roller presses the sheet 4 against the intermediate transfer belt 30, thereby improving transfer efficiency.

After the transfer of the full-color image onto the sheet 4, the fixing device 16 fixes the full-color image on the sheet 4. The fixing device 16 ejects the sheet 4 outside the image forming apparatus 100 after fixing the full-color image thereon.

<Hardware Configuration>

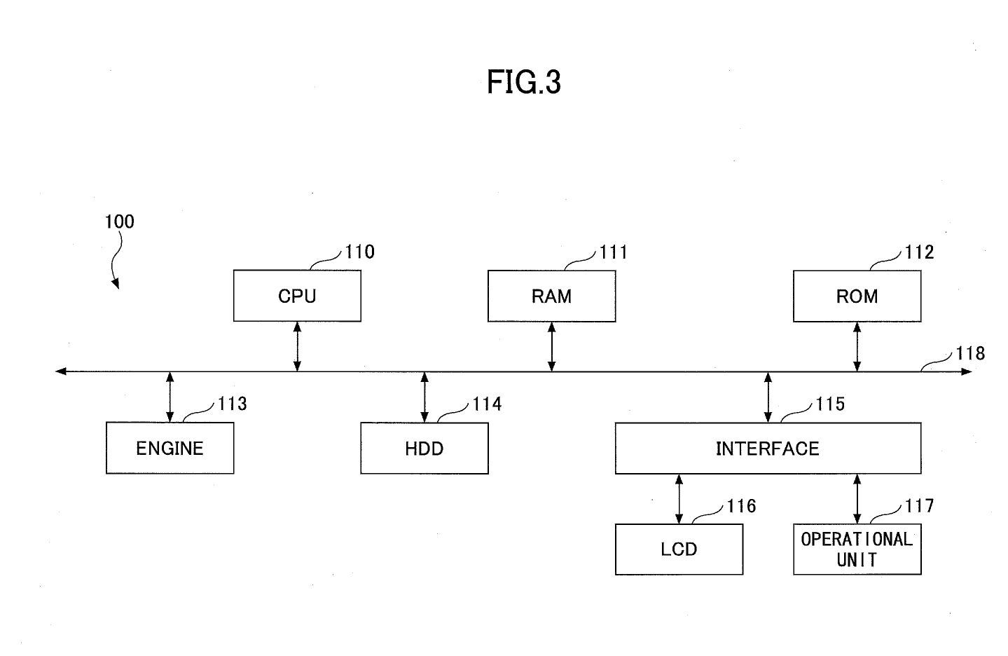

FIG. 3 is a diagram illustrating an example hardware configuration of the image forming apparatus 100 of the present embodiment.

As shown in FIG. 3, the image forming apparatus 100 of the present embodiment has a general configuration of a server or a PC (Personal Computer). In addition, the image forming apparatus 100 includes an engine 113 for performing image forming operation. That is, the image forming apparatus 100 includes a CPU (Central Processing Unit) 110, a RAM (Random Access Memory) 111, a ROM (Read Only Memory) 112, the engine 113, a HDD (Hard Disk Drive) 114 and Interface 115, where the respective elements are connected via a bus 118.

A LCD (Liquid Crystal Display) 116 and an operational unit 117 are coupled to the interface 115.

The CPU 110 is a calculation unit for controlling entire operation of the image forming apparatus 100.

The RAM 111 is a volatile memory from/into which data can be quickly read/written. The RAM 111 is used as a work area for the CPU 110 performing information processing.

The ROM 112 is a non-volatile memory for storing read-only data, in which programs such as firmware is stored.

The engine 113 is a mechanism for performing an actual image forming operation in the image forming apparatus 100.

The HDD 114 is a non-volatile storage medium for storing data therein and retrieving data therefrom, in which OS (Operating System), respective control programs, application programs, etc. are stored.

The interface 115 controls bus 118, hardware, network, and the like.

The LCD 116 is a visual user interface for showing a user a state in which the image forming apparatus 100 is. The operational unit 117 includes user interfaces for inputting information into the image forming apparatus 100, such as a keyboard and a mouse.

In the hardware configuration described above, programs stored in the ROM 112, the HDD 114, an optical disk (not shown), etc., are retrieved and loaded into the RAM 111. When the CPU 110 executes the program to perform processes in accordance with the program, software control units are formed. In this way, functional blocks for achieving the image forming apparatus 100 of the present embodiment are configured by combination of the software control units and the hardware.

<Functional Configuration>

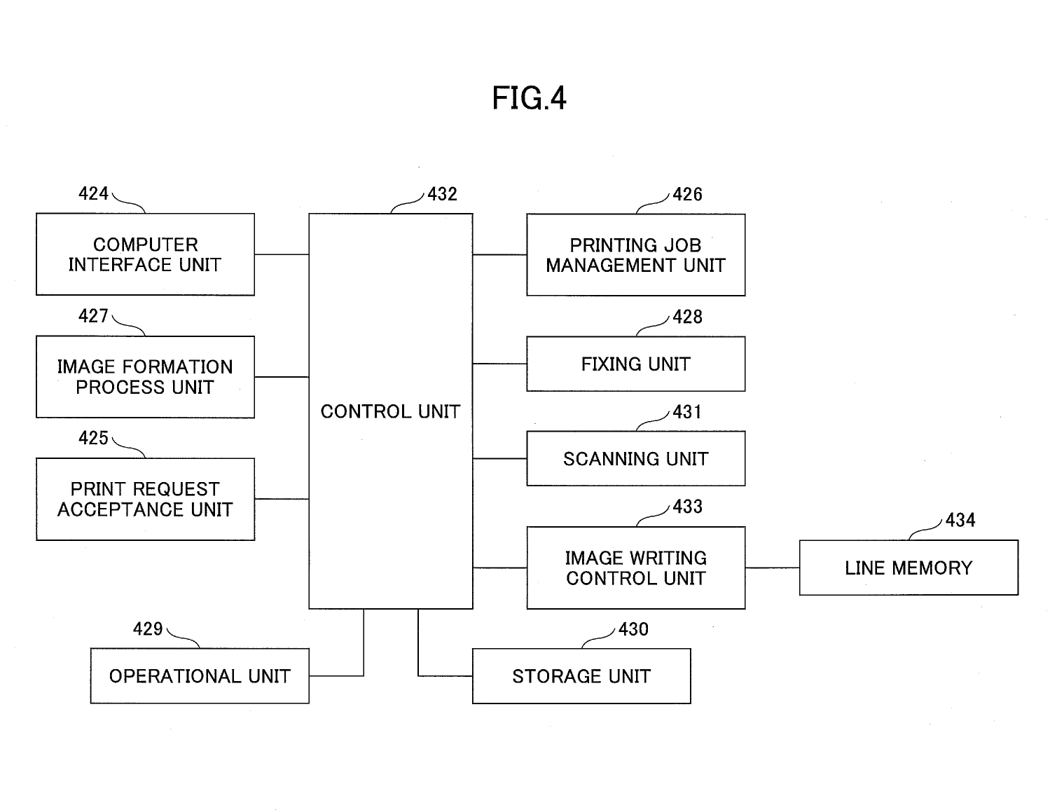

FIG. 4 is a diagram illustrating a functional configuration of the image forming apparatus 100 of the present embodiment.

The image forming apparatus 100 includes a computer interface unit 424, an image formation process unit 427, a print request acceptance unit 425, an operational unit 429, a control unit 432, a printing job management unit 426, a fixing unit 428, a scanning unit 431, an image writing control unit 433, a line memory 434 and a storage unit 430.

The computer interface 424 relays signals transmitted/received between a terminal such as a computer and the image forming apparatus 100.

The print request acceptance unit 425 accepts a print request from the terminal via the computer interface 424, and requests to the control unit 432 to process the print request.

The printing job management unit 426 manages a sequence of the print requests accepted by the image forming apparatus 100.

The image formation process unit 427 forms a toner image on the photoconductor drum 9 to transfer it onto the sheet 4 in cooperation with the image writing control unit 433. Also, upon a positional deviation, etc., being detected in a printing operation, the image formation process unit 427 performs the correction operation.

The fixing unit 428 heats and presses the sheet 4 on which the toner image has been transferred, thereby fixing the toner image.

Upon accepting operational inputs from the user to the image forming apparatus 100, the operational unit 429 reports the operational inputs to the control unit 432. Also, the operational unit 429 displays a state of the image forming apparatus 100 for the user.

The scanning unit 431 converts the information formed on the sheet 4 into image data, and requests the storage unit 430 to store the image data.

The storage unit 430 stores information required for operations of the image forming apparatus 100. The storage unit 430 receives the image data from the terminal and the scanning unit 431 to store it.

The storage unit 430 stores information related to an illuminating process of image scanning head 11 included in the image writing control unit 433. Detailed descriptions thereof will be given below.

The image writing control unit 433 includes a image scanning head 11. The image writing control unit 433 generates pixel data on a color-by-color basis, by performing an image processing operation on the image data of the print request. The image writing control unit 433 has the image scanning head 11 illuminates so as to form a latent image corresponding to the generated pixel data on the photoconductor drum 9.

The illuminating process of the image scanning head 11 will be described below.

The control unit 432 controls respective functional blocks.

<First Adjustment of Light Emitting Period of Image Writing Control Unit>

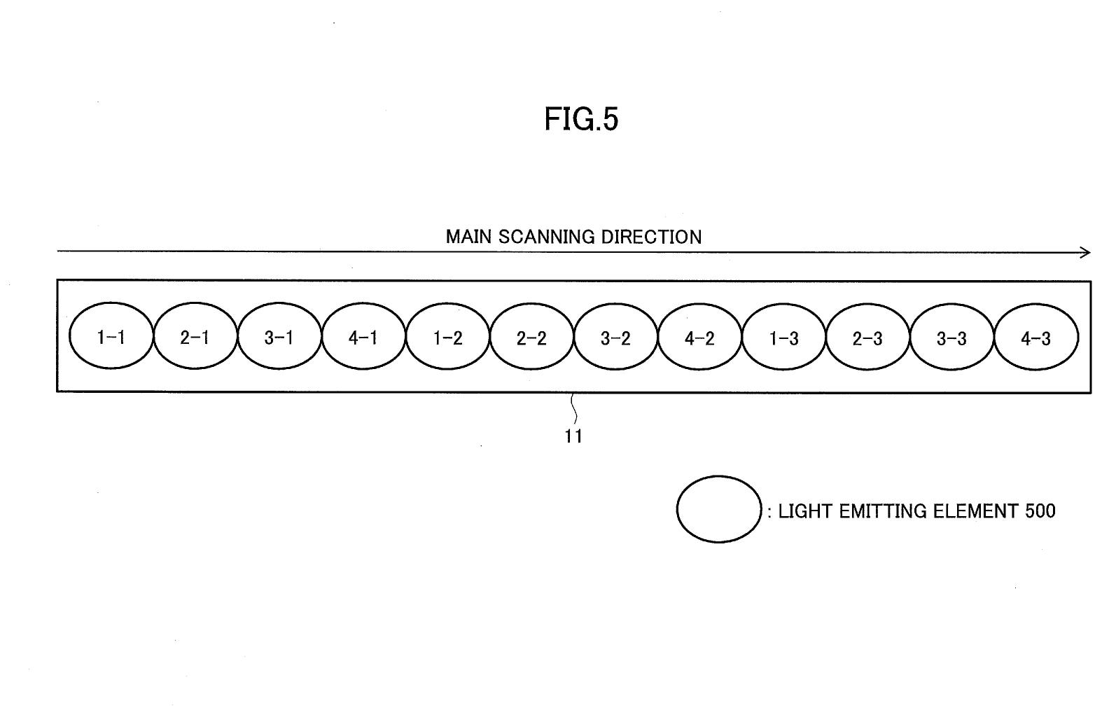

Adjustment of light emitting period of the image writing control unit 433 will be described with reference to FIG. 5 to FIG. 11.

FIG. 5 is a diagram illustrating an example configuration of the image scanning head 11 of the present embodiment.

The image scanning head 11 is provided with respect to each toner color. As shown in FIG. 5, the image scanning head 11 includes a plurality of light emitting elements 500. The light emitting elements 500 is achieved by a LED element, an organic EL element, or the like. In the example shown in FIG. 5, the image scanning head 11 includes 12 light emitting elements 500 arranged along a main scanning direction. The image scanning head 11 is controlled by the image writing control unit 433.

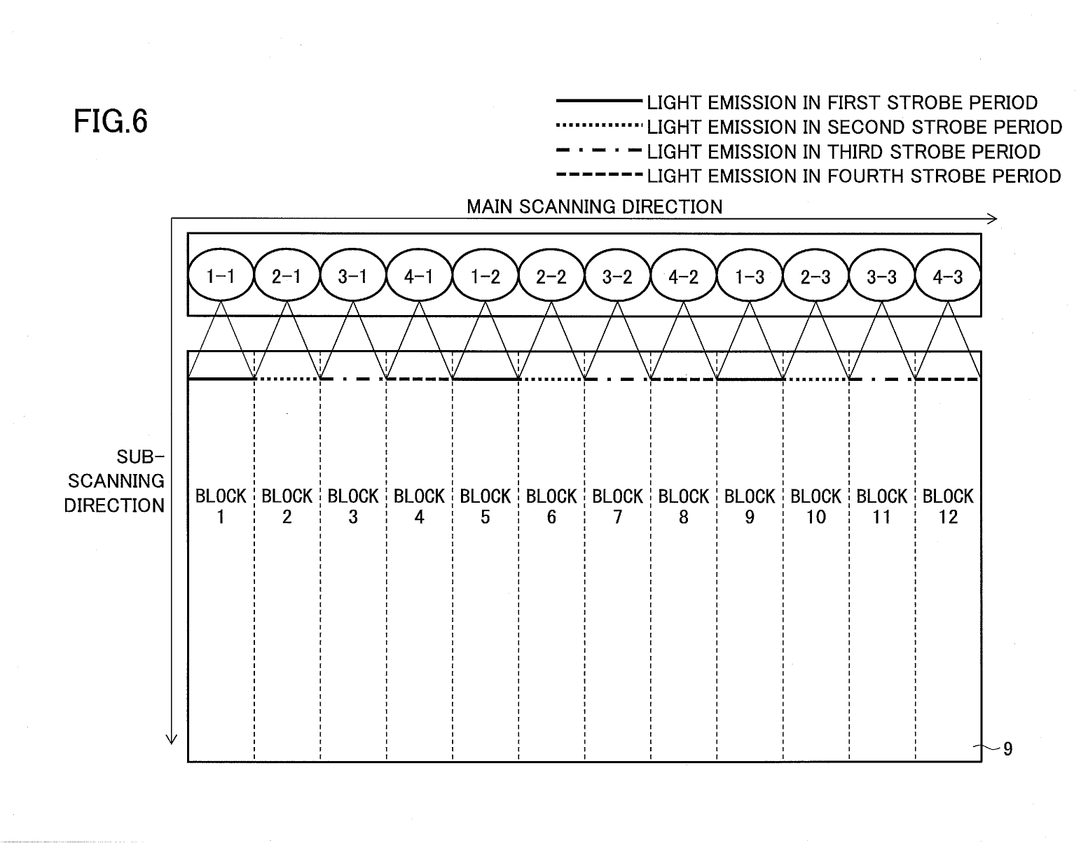

FIG. 6 is a diagram illustrating an example illuminating process of the image scanning head 11 emitting the light onto the photoconductor drum 9.

In the present embodiment, the photoconductor drum 9 is divided into blocks 1-12 in the main scanning direction, where a number of the light emitting elements 500 are twelve. The respective light emitting elements 500 emit the light on the corresponding blocks of photoconductor drum 9.

Additionally, although 12 blocks are formed with the 12 light emitting elements 500 in the present embodiment, this is not a limiting example. For example, 1000 light emitting elements 500 may be included in the image forming apparatus 100 so as to from 1000 blocks, and the illuminating process may be performed on the respective blocks of the photoconductor drum 9. Alternatively, a light emitting element 500 that has a plurality of smaller light emitting elements may emit the light to the respective blocks. For example, the 12 light emitting elements 500 may respectively include approximate 100 smaller light emitting elements.

The image writing control unit 433 performs the illuminating process on a line-by-line basis in the main scanning direction by using the image scanning head 11.

The image writing control unit 433 does not cause all the light emitting elements 500 included in the image scanning head 11 to emit the light simultaneously, but the image writing control unit 433 causes the light emitting elements 500 divided into groups to emit the light, where the light emitting elements 500 of the respective groups emit the light in a predetermined order.

In a case where “1-1”, “1-2” and “1-3” of the light emitting elements 500 belong to “group 1”, the image writing control unit 433 causes the light emitting elements 500 belonging to the group 1 to emit the light while a first strobe signal is active (first strobe period).

Similarly, in a case where “2-1”, “2-2” and “2-3” of the light emitting elements 500 belong to “group 2”, the image writing control unit 433 causes the light emitting elements 500 belonging to the group 2 to emit the light while a second strobe signal is active (second strobe period).

In a case where “3-1”, “3-2” and “3-3” of the light emitting elements 500 belong to “group 3”, the image writing control unit 433 causes the light emitting elements 500 belonging to the group 3 to emit the light while a third strobe signal is active (third strobe period).

In a case where “4-1”, “4-2” and “4-3” of the light emitting elements 500 belong to “group 4”, the image writing control unit 433 causes the light emitting elements 500 belonging to the group 4 to emit the light while a fourth strobe signal is active (fourth strobe period).

The image writing control unit 433 completes the illuminating process corresponding to one line of the main scanning direction by causing the light emitting elements 500 of the image scanning head 11 to respectively emit the light in the first strobe period to the fourth strobe period. The image scanning head 11 repeats to perform the illuminating process according to lines of the scanning direction.

Here, the group consists of the plurality of light emitting elements 500 is an example light emitting body.

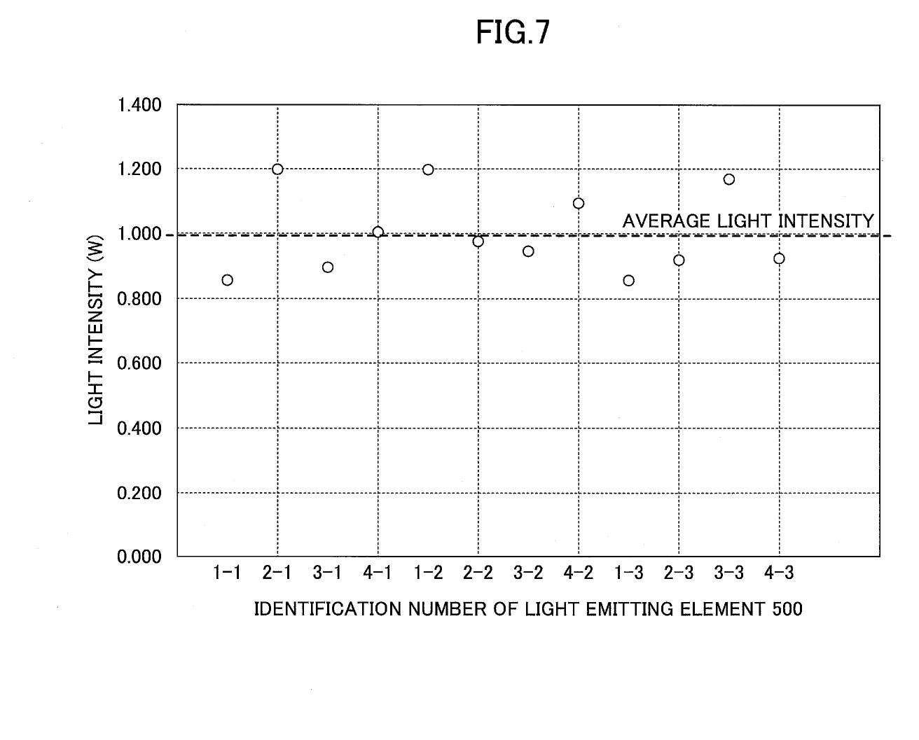

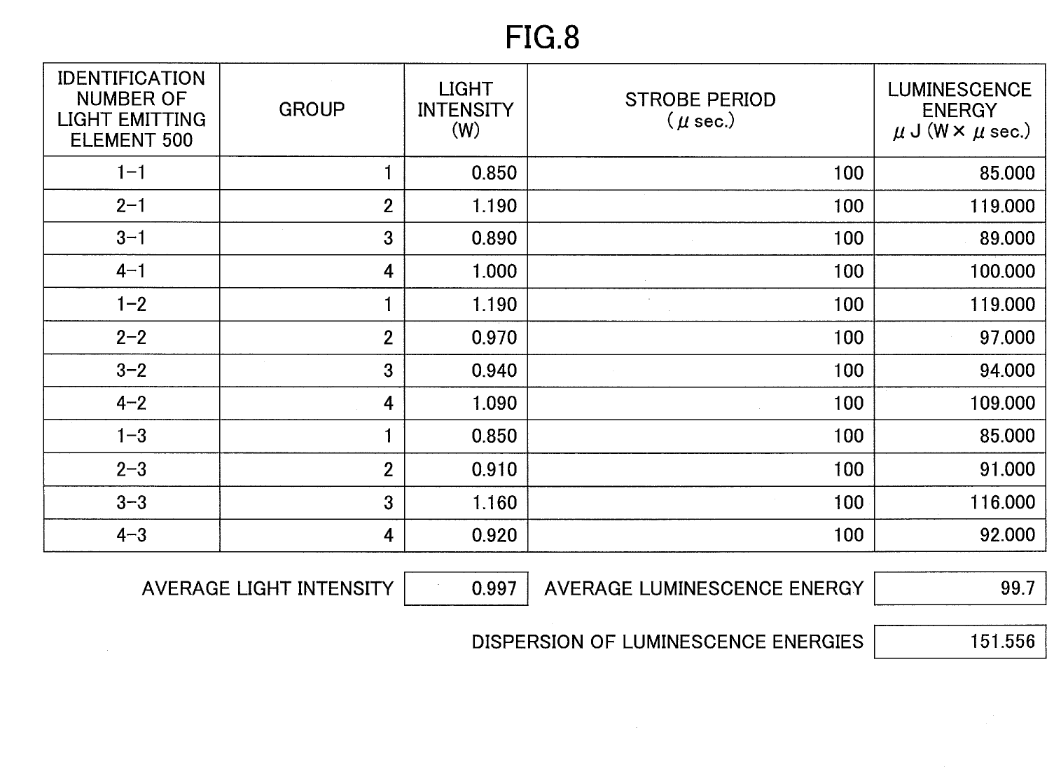

FIG. 7 is a diagram illustrating an example light intensities of light emitting elements 500, where the respective light emitting elements 500 are operated with a predetermined electric power. The light intensity varies even if light emitting elements 500 are operated with a predetermined electric power because the respective light emitting elements 500 have discrete luminescence characteristics. Therefore, unevenness of the image intensity of the image formed on the sheet 4 may be occurred in a case where the light emitting elements 500 emit the light in the same period. FIG. 8 is a diagram illustrating example luminescence energies corresponding to the respective light emitting elements 500.

The luminescence energy (or light emission energy) can be found by multiplying the light intensity of the light emitting element 500 by the strobe period in which the strobe signal is active.

The luminescence energy varies in a case where the light emitting elements 500 emit the light in the same strobe period because the light intensities of the light emitting elements 500 are not the same.

In the present embodiment, difference between the luminescence energy of the light emitting elements 500 are reduced by adjusting light emitting periods of the respective groups. Specifically, the image writing control unit 433 adjusts the light emitting periods of the respective groups so as to make the luminescence energies of the respective groups more even.

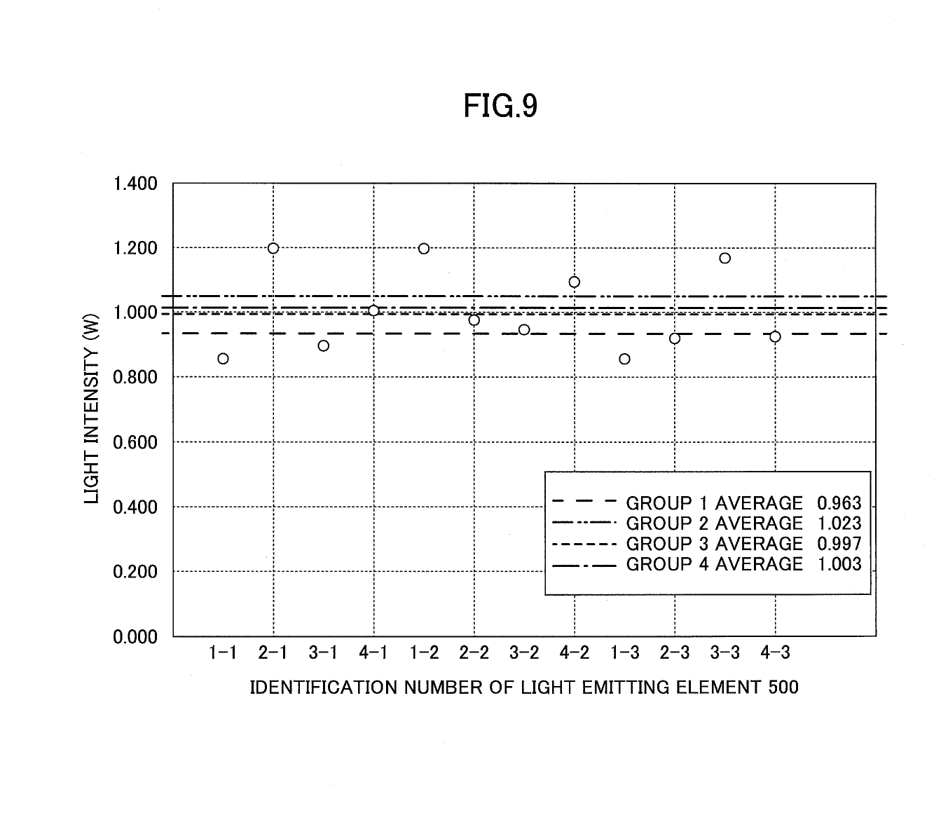

FIG. 9 is a diagram illustrating example average light intensities of respective groups of the light emitting elements 500. The light intensities of the respective light emitting elements 500 are the same as those shown in FIG. 8. For example, the average light intensity of the light emitting elements 500 belonging to the group 1 is 0.963 W (=(0.850+1.190+0.850)/3).

According to FIG. 9, the average light intensity of the light emitting elements 500 belonging to the group 1 is low, while the average light intensity of the light emitting elements 500 belonging to the group 2 is high.

Therefore, the image writing control unit 433 adjusts the strobe periods so that the first strobe period for the light emitting elements 500 of the group 1 becomes longer while the second strobe period for the light emitting elements 500 of the group 2 becomes shorter. In the following, an example adjustment method will be described.

In the present embodiment, the image writing control unit 433 adjusts the illuminating periods so that the averages of the luminescence energies of the respective groups become closer to an average of the luminescence energies of all light emitting elements 500 included in the image scanning head 11 that emit the light in the same illuminating period.

As shown in FIG. 8, in a case where all the light emitting elements 500 included in the image scanning head 11 emit the light in 100 μsec, the average of the luminescence energy of one light emitting element 500 is 99.7 μJ.

In order to make the average of the luminescence energies of the light emitting elements 500 belonging to the group 1 closer to 99.7 (μJ), the first strobe period is adjusted in a manner described below.

First strobe period (μsec)=99.7 (ρJ)/0.963 (W)=103 (μsec)

Here, “0.963 (W)” indicates the average of the light intensities of the light emitting elements 500 belonging to the group 1.

Through similar calculations, the second strobe period becomes 97 (μsec), the third strobe period becomes 100 (μsec) and the fourth strobe period becomes 99 (μsec).

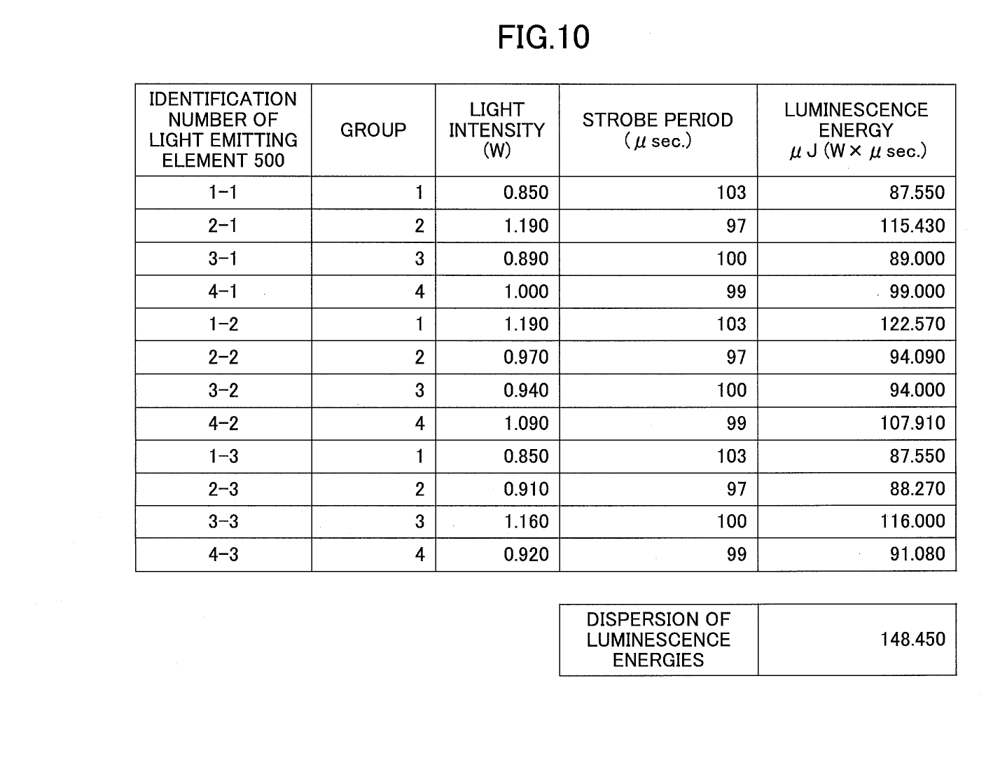

FIG. 10 is a diagram illustrating a summarized relationship between the light intensities, the strobe periods and the luminescence energies of the light emitting elements 500.

According to FIG. 8 and FIG. 10, a dispersion of the luminescence energies can be reduced by adjusting the strobe periods. A value of the dispersion before the adjustment is 151.556, whereas the value of the dispersion after the adjustment is 148.450.

Here, the dispersion can be found by the flowing formula.

Dispersion=Σ(energy of light emitting element 500 (i)−average energy of light emitting element 500)²/(N−1).

The energy of light emitting element 500 (i) means each of energies of the light emitting elements 500 included in the image scanning head 11. “N” becomes 12 in a case where 12 light emitting elements 500 are included in the image scanning head 11.

The dispersion of luminescence energies of all light emitting elements 500 can be reduced by adjusting the strobe periods. Thus, the unevenness of the image intensity in printing operation is unlikely to occur by adjusting the strobe periods.

Additionally, the light intensity of the light emitting element 500 is an example performance of the light emitting element 500, and the luminescence energy of the light emitting element 500 is an example capability of the light emitting elements 500. Also, the average of the light intensities of the light emitting elements 500 belonging to a group is an example performance of the light emitting body, and the average of the luminescence energies of the light emitting elements 500 belonging to a group is an example capability of the light emitting body.

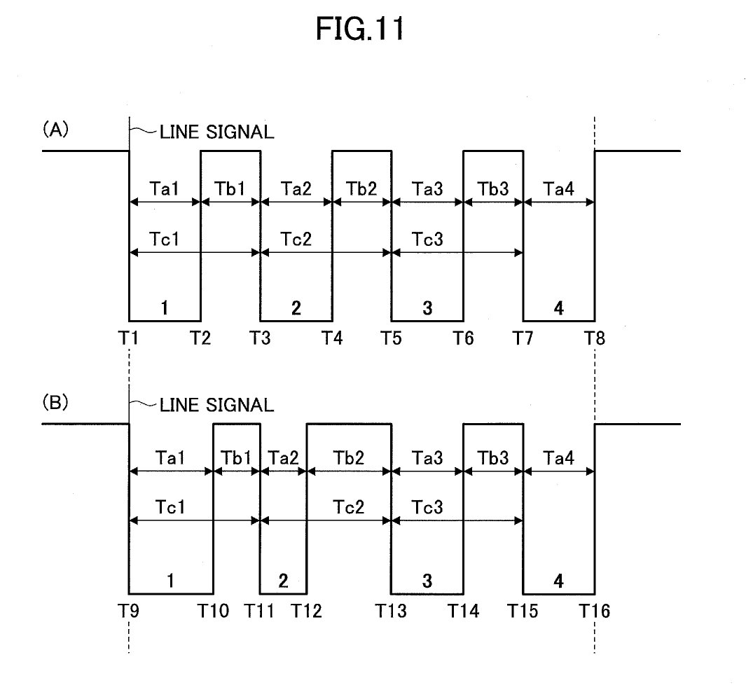

FIG. 11 is a timing diagram illustrating an example timing control of the present embodiment. FIG. 11 (A) shows a timing diagram corresponding to the strobe periods before the adjustment, while FIG. 11 (B) shows the timing diagram corresponding to the strobe periods after the adjustment.

Ta (Ta1-Ta4) indicates a period in which the strobe signal is active, that is, the strobe period. Ta1, Ta2, Ta3 and Ta4 respectively correspond to the first strobe period, the second strobe period, the third strobe period and the fourth strobe period.

Tb (Tb1-Tb3) indicates a period in which the strobe signal is not active, that is, a strobe interval. The strobe interval means a standby time for next light emission.

Tc (Tc1-Tc3) indicates a strobe cycle, which includes Ta and Tb.

The light emitting element 500 emits the light in the strobe period Ta, while the light emitting element 500 does not emit the light in the strobe interval Tb.

Upon finishing the fourth strobe period Ta4, the illuminating process with respect to one line by the image scanning head 11 is completed. Upon receiving a line signal, the image scanning head 11 starts the illuminating process with respect to the next line. That is, upon receiving the line signal, the first strobe period starts and the light emitting elements 500 belonging to the group 1 start to emit the light.

Here, the line signal is a signal for synchronizing the timing of the illuminating process with respect to each of lines.

In FIG. 11 (A), Ta1, Ta2, Ta3 and Ta4 are respectively 100 μsec.

In FIG. 11 (B), after adjusting the strobe periods, Ta1 is 103 μsec, Ta2 is 97 μsec, Ta3 is 100 μsec and Ta4 is 99 μsec.

In FIG. 11, the strobe cycle Tc does not change before and after the adjustment.

When the strobe cycle Tc does not change before and after the adjustment, a position of the photoconductor drum 9 to which the light emitting elements 500 emit the light can be stabilized in a sub-scanning direction.

During the light emission of the light emitting elements 500 in the main scanning direction of the photoconductor drum 9, the photoconductor drum 9 slightly moves in the sub-scanning direction. If the strobe cycle Tc is adjusted so as to be changed from that before the adjustment, a light emission position of the light emitting elements 500 in the sub-scanning directions varies before and after the adjustment. Therefore, image quality may be deteriorated when the toner images of respective colors are combined.

In the example adjustment of the strobe period Ta shown in FIG. 11, the strobe cycle Tc does not change before and after the adjustment. Hence, the light emission positions of respective groups of the light emitting elements 500 do not vary. Thus, the deterioration of the image quality when combining the toner images of the respective colors can be suppressed.

Specifically, in FIG. 11 (A) and FIG. 11 (B), the strobe frequencies Tc1, Tc2 and Tc3 are the same. After performing the adjustment, the sum of the strobe period Ta and the strobe interval Tb does not change from that before the adjustment. For example, Ta1 (T1-T2) before adjusted is 100 μsec, while Ta1 (T9-T10) after the adjustment is 103 μsec. The strobe period Ta1 is extended by 3 μsec through the adjustment. Accordingly, Tb1 (T10-T11) after the adjustment is shorter than Tb1 (T2-T3) before the adjustment by 3 μsec. Other strobe periods Ta and strobe intervals Tb are adjusted similarly.

Additionally, since time taken for the illuminating process with respect to one line is the same regardless of the color of the toner image, time taken for forming the latent image on the photoconductor drum 9 is also the same. It stands to reason that a number of lines in the sub-scanning direction with which the latent image is formed on the photoconductor drum 9 is the same in respective photoconductor drums 9.

Although the light emitting elements 500 emit the light in the strobe period, the light intensities of the light emitting elements 500 vary during formation of the latent image on the photoconductor drum 9 in accordance with the image intensity of the toner image corresponding to the light emission position. Therefore, it should be noted that the light intensity of the light emitting elements shown in FIG. 8 and FIG. 10 are described assuming that the toner image is formed at a predetermined image intensity.

<Light Emitting Periods Stored in Storage Unit>

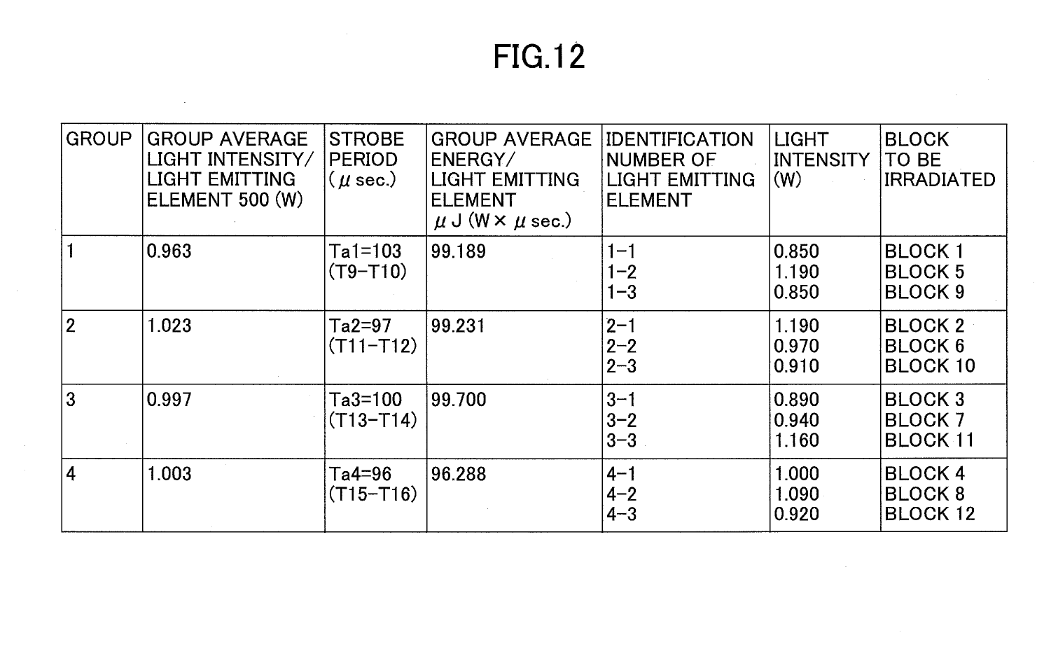

FIG. 12 is a diagram illustrating information related to light emitting periods of the present embodiment.

The storage unit 430 stores information related to light emitting periods adjusted by the image writing control unit 433.

Specifically, information shown in FIG. 12 is stored. The storage unit 430 stores group that emits the light in a time-division manner, a group average light intensity/light emitting element 500 (W), the light emitting period (μsec), a group average energy/light emitting element 500 (μJ), the strobe period, identification numbers of the light emitting elements 500 belonging to respective groups, the light intensities of the respective light emitting elements 500 and blocks to be irradiated by the respective light emitting elements 500. The strobe period includes a timing for starting light emission and a timing for finishing light emission. For example, in a case of group 1, the timing T9 for starting light emission and the timing T10 for finishing light emission are stored.

Additionally, the storage unit 430 may only store the group average light intensity without storing the light intensities of the respective light emitting elements 500. Also, the group to which the light emitting elements 500 belong may be defined automatically in accordance with their hardware elements, and the relationship between the light emitting elements 500 and the groups may not be stored in the storage unit 430. Also, the storage unit 430 may not store the blocks to be irradiated by the respective light emitting elements 500. Positions (corresponding to blocks) on the photoconductor drum 9 on which the respective light emitting elements 500 perform the illuminating process may not be stored in the storage unit 430 in a case where the group to which the light emitting elements 500 belong is defined automatically in accordance with their hardware elements.

That is, in a case where the group to which the light emitting elements 500 belong is defined automatically in accordance with their hardware elements, the storage unit 430 may store the information related to the group average light intensity and the strobe period. Here, the strobe period includes the timing for starting light emission and the timing for finishing light emission.

Additionally, information related to the adjusted light emitting period, etc., may be stored in a memory included in the image scanning head 11. For example, the memory may be a non-volatile memory such as an EEPROM.

<Second Adjustment of Light Emitting Period of Image Writing Control Unit>

(1) Shortening of Strobe Interval

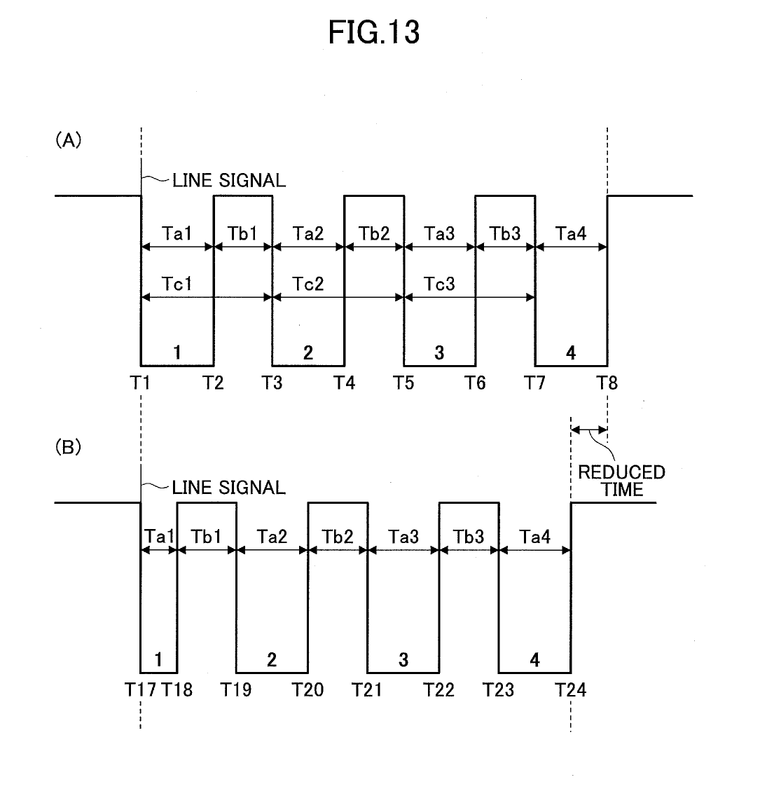

FIG. 13 is a timing diagram illustrating an example timing control of the present embodiment. FIG. 13 (A) shows a timing diagram before the strobe period and the strobe interval are adjusted. FIG. 13 (B) shows a timing diagram after the strobe period and the strobe interval are adjusted.

In addition to the adjustment of the strobe periods, the image writing control unit 433 may shorten the strobe intervals (Tb1-Tb3). Thus, time taken for illuminating process with respect to one line can be shortened.

The photoconductor drum 9 slightly moves in sub-scanning direction during the illuminating process. Therefore, in a case where the strobe cycle is long, a linearity of exposure points on the photoconductor drum 9 may not be maintained, where the exposure points are irradiated in respective illuminating processes of discrete groups. When shortening the strobe intervals, the strobe cycle becomes shorter, and the image writing control unit 433 can perform the illuminating processes so that the linearity of exposure points can be maintained.

Preferably, the strobe interval is shortened as much as possible in order to maintain the linearity. The image writing control unit 433 may determine the shortest strobe interval taking account of individual differences of the image scanning head 11, a limitations due to the hardware configuration, and the like.

Additionally, in a case where the strobe interval is shortened, the time taken for the illuminating process with respect to one line, that is, an interval between the line signals, is kept uniform.

Also, the image writing control unit 433 may determine the longest settable strobe interval. The longest settable strobe interval may be determined taking account of reception timings of the line signals.

The storage unit 430 may store the shortest strobe interval and the longest strobe interval.

(2) Setting Shortest Strobe Period

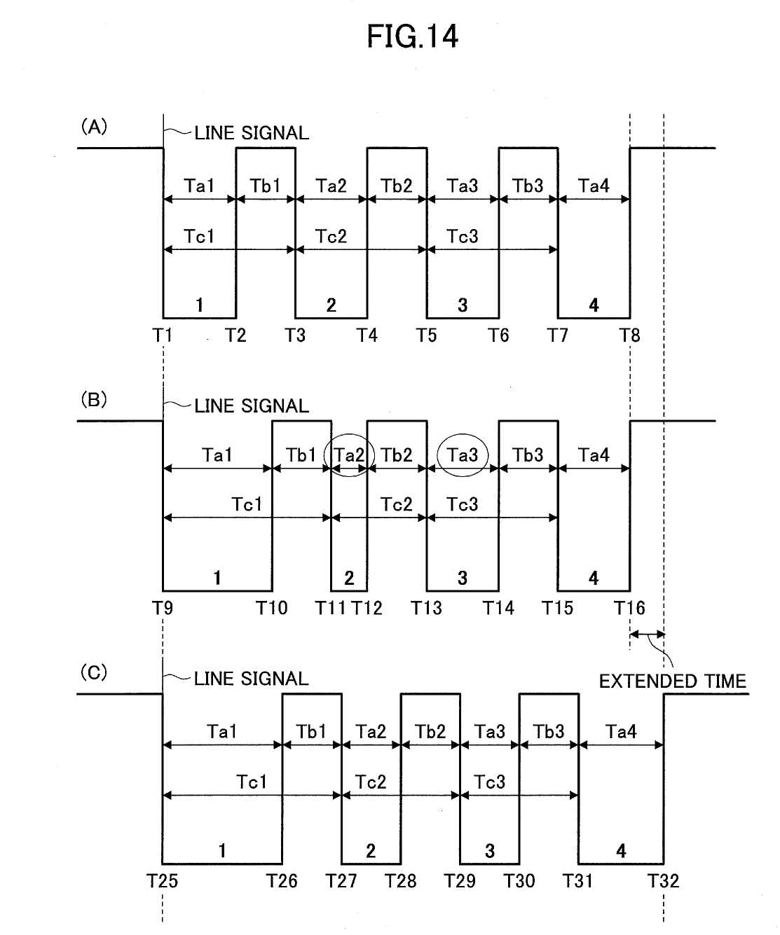

FIG. 14 is a timing diagram illustrating an example timing control of the present embodiment. FIG. 14 (A) shows a timing diagram before the strobe period and the strobe interval are not adjusted.

In the example described above, the strobe periods Ta1-Ta4 are adjusted so that the averages of luminescence energies of the light emitting elements 500 of the respective groups become closer to the average luminescence energy 99.7 (μJ) of all the light emitting elements 500 included in the image scanning head 11.

FIG. 14 (B) shows a timing diagram after the strobe period is adjusted. Ta1 after the adjustment is 103 (μsec), Ta2 after the adjustment is 97 (μsec), Ta3 after the adjustment is 100 (μsec), Ta4 after the adjustment is 96 (μsec).

The storage unit 430 stores the shortest settable strobe period. The shortest strobe period is set taking account of the performance of the light emitting element 500, e.g., the shortest possible light emitting period of the light emitting element 500.

The luminescence energies of the light emitting elements 500 belonging to one group may be so high that differences between the luminescence energies of the light emitting elements 500 belonging to other groups may not become small enough even after setting the strobe period thereof to be the shortest strobe period.

For example, in a case where the shortest strobe period is 99 (μsec), the strobe period after the adjustment needs to be greater than or equal to 99 (μsec). In the example described above, the strobe period Ta2 of the group 2 after the adjustment is 97 (μsec) and the strobe period Ta3 of the group 3 after the adjustment is 96 (μsec). In this case, the respective strobe periods need to be adjusted again so that the respective strobe periods become greater than or equal to the shortest strobe period 99 (μsec).

For example, the average luminescence energy of the light emitting elements 500 in the respective groups may be adjusted so as to become closer to a target value. Here, the target value is greater than the average luminescence energy of all the light emitting elements 500. The strobe periods of the respective groups can be found as described below.

Strobe period of a group=target value/average luminescence energy of light emitting elements 500 in the group

For example, in a case where the target value is 105 (ρJ), the first strobe period Ta1 is 109 (μsec), the second strobe period Ta2 is 102.6 (μsec), the third strobe period Ta3 is 105.3 (μsec) and the fourth strobe period Ta4 is 104.7 (μsec).

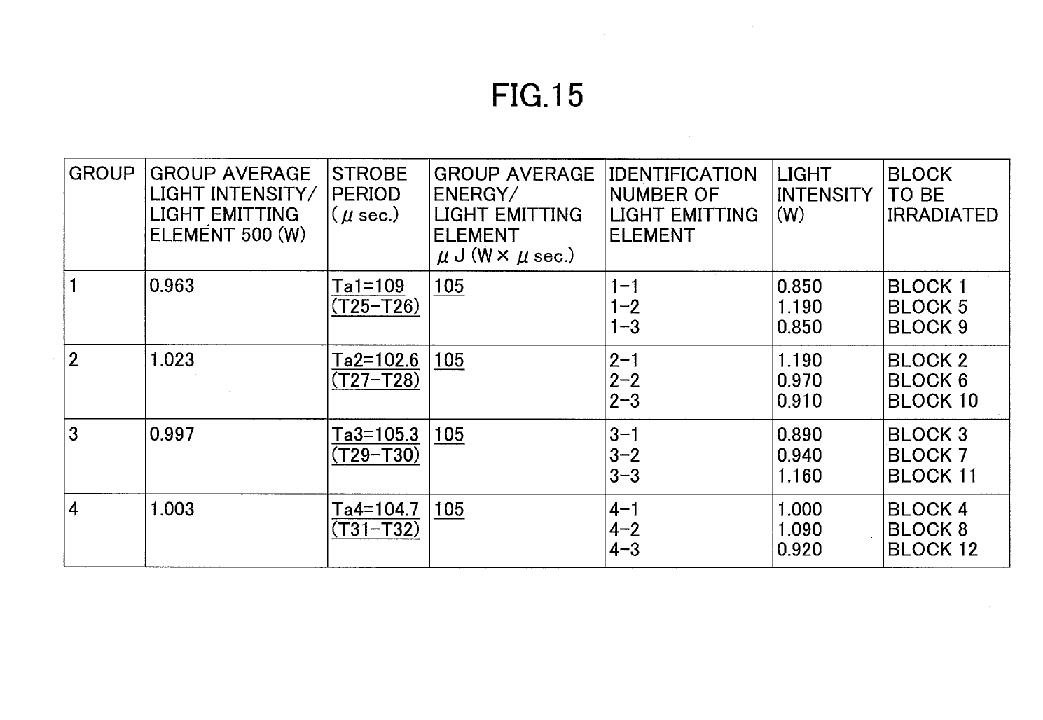

FIG. 14 (C) shows a timing diagram after readjustment. Also, the relationship between the strobe period and the group average of the luminescence energy after the adjustment is shown in FIG. 15.

The storage unit 430 stores the adjustment result shown in FIG. 15, and the image writing control unit 433 controls writing operations with reference to the adjustment result.

Here, the image writing control unit 433 may set the target value so that the strobe period of a group whose average light intensity of the light emitting elements 500 is the highest among the groups becomes the shortest strobe period.

In the present embodiment, the highest average light intensity of the light emitting elements 500 is 1.023 (W) of the group 2.

The shortest strobe period is 99 (μsec). Therefore, the target value can be found as described below.

Target value=1.023 (W)×99 (μsec)=101.277 (μJ)

In this case, the first strobe period Ta1, the third strobe period Ta3 and the fourth strobe period Ta4 are 105.2 (μsec), 101.6 (μsec) and 101.0 (μsec).

When the strobe periods are adjusted again taking account of the shortest strobe period, the time taken for the illuminating process with respect to one line is extended (FIG. 14C). The image writing control unit 433 starts to perform writing operation of the next line upon receiving the line signal. Therefore, the strobe period needs to be adjusted so that the illuminating process with respect to one line can be completed within a cycle of the line signal.

In addition, as shown in FIG. 14 (C), in a case where the average luminescence energy of the light emitting elements 500 in the respective groups are adjusted so as to become closer to a target value, energy consumed in the illuminating process of the image scanning head 11 becomes greater in comparison to a case where the averages of luminescence energies of the light emitting elements 500 of the respective groups are adjusted so as to become closer to the average luminescence energy of all the light emitting elements 500 included in the image scanning head 11. Thus, the image intensity of the toner image formed on the photoconductor drum 9 may be too large. Therefore, the processes of the development device 12 and the transfer device 15 need to be adjusted.

(3) Setting Longest Strobe Period

The storage unit 430 stores the longest settable strobe period. The longest strobe period is set in advance taking account of hardware performance of the image scanning head 11, power consumption rate of the image scanning head 11, current value, receiving interval of the line signal, and the like.

The luminescence energies of the light emitting elements 500 belonging to one group may be so little that differences between the luminescence energies of the light emitting elements 500 belonging to other groups may not become small enough even after setting the strobe period thereof to be the longest strobe period.

For example, in a case where the longest strobe period is 102 (μsec), the strobe period after adjusted needs to be equal to or less than 102 (μsec). In the example described above, the strobe period Ta1 of the group 1 after the adjustment is 103 (μsec). In this case, the respective strobe periods need to be adjusted again so that the respective strobe periods become equal to or less than the longest strobe period 102 (μsec).

The image writing control unit 433 may set the target value so that the strobe period of a group whose average light intensity of the light emitting elements 500 is the smallest among the groups becomes the longest strobe period.

In the present embodiment, the smallest average light intensity of the light emitting elements 500 is 0.963 (W) of the group 1.

The longest strobe period is 102 (μsec). Therefore, the target value can be found as described below.

Target value=0.963 (W)×102 (μsec)=98.226 (μJ)

In this case, the strobe period can be found as described below.

Strobe period=target value/average light intensity of light emitting elements 500 in the group

Thus, the second strobe period Ta2, the third strobe period Ta3 and the fourth strobe period Ta4 are 96.0 (μsec), 98.5 (μsec) and 97.9 (μsec).

In this case, energy consumption in the image scanning head 11 performing the illuminating process becomes smaller in comparison to a case where the averages of luminescence energies of the light emitting elements 500 of the respective groups are adjusted so as to become closer to the average luminescence energy of all the light emitting elements 500 included in the image scanning head 11. Thus, the image intensity of the toner image formed on the photoconductor drum 9 may be too small. Therefore, the processes of the development device 12 and the transfer device 15 need to be adjusted.

(4) Setting Other Strobe Periods

In addition to the adjustment method described above, the strobe period may be adjusted while the strobe interval is shortened. That is, “(1) shortening of strobe interval” and “(2) setting shortest strobe period” or “(3) setting longest strobe period” may be combined.

In this case, the time taken for the illuminating process with respect to one line may be extended or may be shortened.

However, in a case where the time taken for the illuminating process with respect to one line is extended, a reception timing of the next line signal needs to be considered because the image writing control unit 433 starts to perform the illuminating process on the next line upon receiving the line signal.

### Second Embodiment

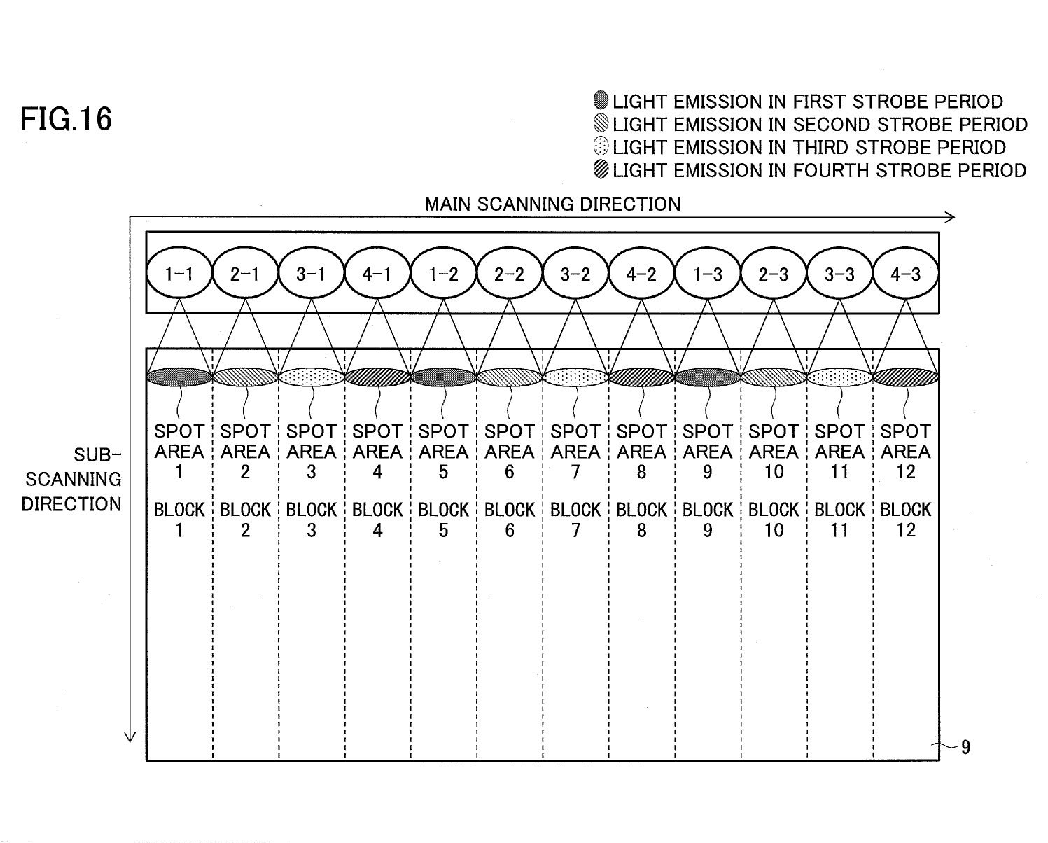

In the following, a second embodiment will be described with reference to FIG. 16 to FIG. 18. Descriptions will be mainly given on differences between the first embodiment and the second embodiment, while descriptions on parts common to the first embodiment and the second embodiment will be omitted.

FIG. 16 is a diagram illustrating an example illuminating process of the image scanning head 11 emitting the light onto the photoconductor drum 9 of the second embodiment.

In the first embodiment, the strobe periods are adjusted so that the averages of luminescence energies of the light emitting elements 500 of the respective groups become to be close to the same value. In the present embodiment, the adjustment is performed based on a diameter of a spot formed on the photoconductor drum 9 in the light emission operation of the light emitting element 500.

As shown in FIG. 16, spots having spot diameters (spot diameters 1-12) or spot areas (spot areas 1-12) are formed on the photoconductor drum 9 when the light emitting elements 500 emit the light. The spot areas vary because the light emitting elements 500 have discrete luminescence characteristics. A value calculated by multiplying the spot diameter (spot area) by the strobe period has a correlation with energy applied on the photoconductor drum 9. Therefore, occurrence of the unevenness of the image intensity of the toner image formed on the photoconductor drum 9 can be suppressed by adjusting the spot diameter and the strobe period.

A similar adjustment method to that of the first embodiment can be adopted in the second embodiment. In this case, “average spot area of the spots formed by light emitting elements 500 of a group”×“strobe period of the group” (cm²×μsec) is adjusted so as to be close to “average spot area of all the spots formed by light emitting elements 500 included in the image scanning head 11”×“strobe period” (cm²×μsec).

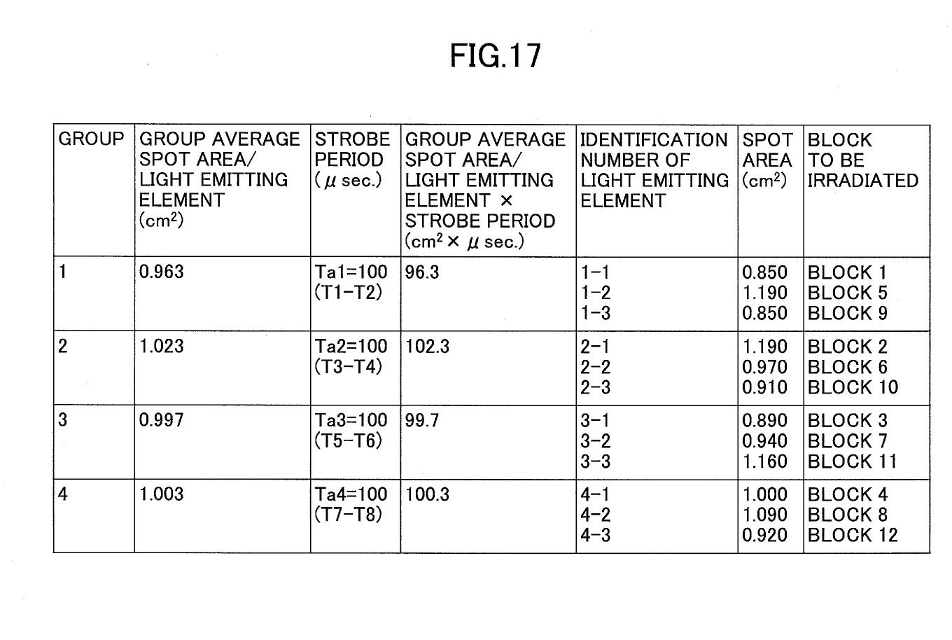

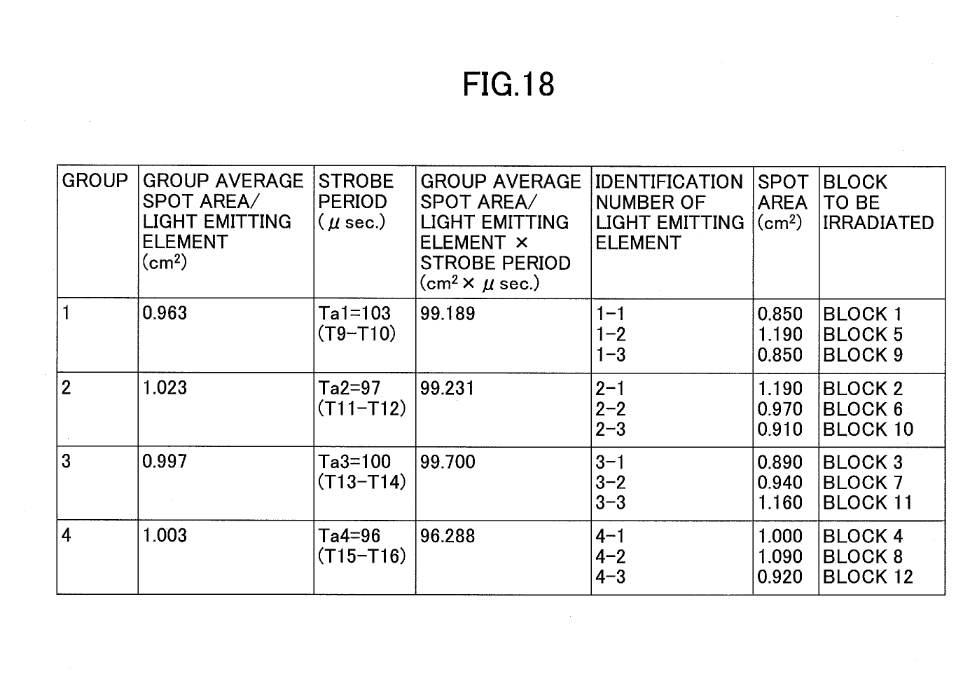

FIG. 17 is a diagram illustrating an example relationship between the spot area and the strobe period before the adjustment of the second embodiment. FIG. 18 is a diagram illustrating an example relationship between the spot area and the strobe period after the adjustment of the second embodiment.

According to FIG. 17, “average spot area of all the spots formed by light emitting elements 500 included in the image scanning head 11”×“strobe period” (cm²×μsec) is 99.7 (cm²×μsec).

The image writing control unit 433 adjusts the strobe periods of the respective groups so that “average spot area of the spots formed by light emitting elements 500 of a group”×“strobe period of the group” (cm²×μsec) becomes 99.7 (cm²×μsec).

The adjustment result of the strobe periods by the image writing control unit 433 is shown in FIG. 18. The first strobe period Ta1 is 103 (μsec), the second strobe period Ta2 is 97 (μsec), the third strobe period Ta3 is 100 (μsec) and the fourth strobe period Ta4 is 96 (μsec).

The storage unit 430 stores the adjustment result shown in FIG. 18, and the image writing control unit 433 controls writing operations with reference to the adjustment result.

When the strobe periods are adjusted, “average spot area of the spots formed by light emitting elements 500 of a group”×“strobe period of the group” (cm²×μsec) in the respective groups become closer to each other, thereby suppressing occurrence of the unevenness of the image intensity of the toner image.

Additionally, in the second embodiment, similarly to the first embodiment, the strobe periods and strobe intervals can be adjusted.

Additionally, the spot diameter or spot area is an example performance of the light emitting element 500, and “spot area×strobe period” is an example capability of the light emitting element 500.

Also, the average spot area of the spots formed by light emitting elements 500 of a group is an example performance of the light emitting body, and “spot area×strobe period” is an example capability of the light emitting body.

### Third Embodiment

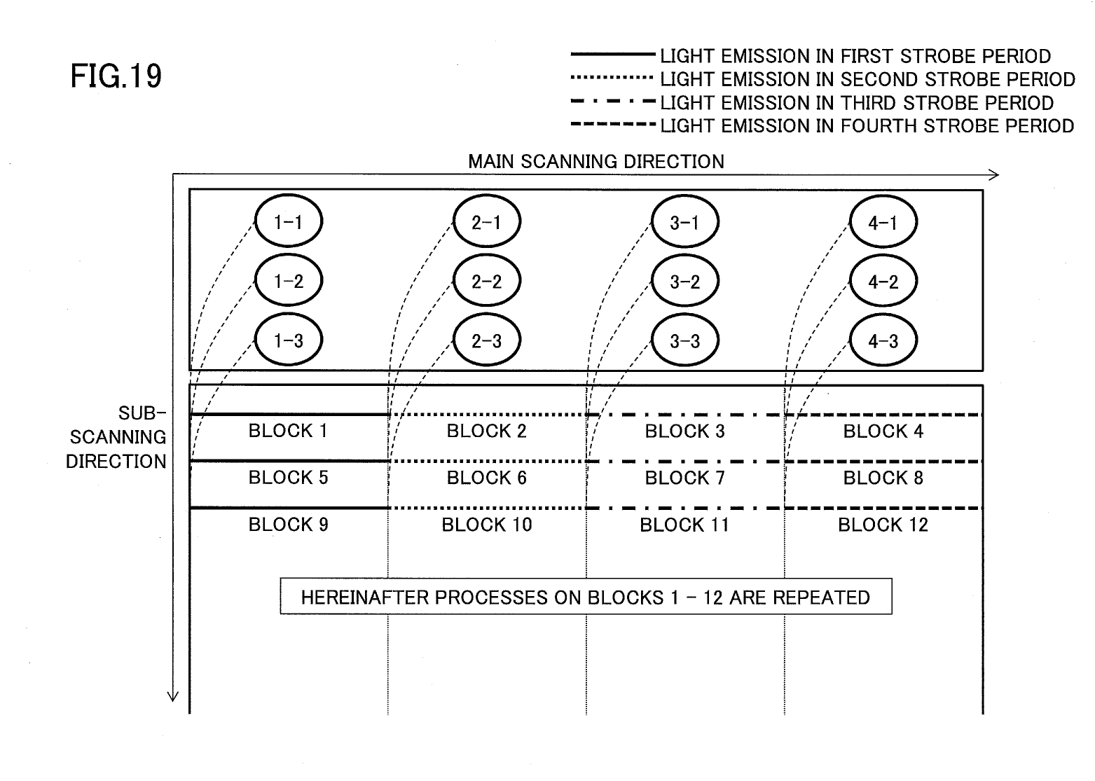

In the following, a third embodiment will be described with reference to FIG. 19. Descriptions will be mainly given on differences from the first embodiment and the second embodiment, while descriptions on parts common to the first embodiment, the second embodiment and the third embodiment will be omitted.

FIG. 19 is a diagram illustrating an example illuminating process of the image scanning head 11 emitting the light to the photoconductor drum 9 of the third embodiment.

Although in the first embodiment and the second embodiment, the light emitting elements 500 are arranged in a line along the main scanning direction of the image scanning head 11, the light emitting elements 500 included in the image scanning head 11 may be arranged in a N-by-M array, wherein N and M are positive integers. In this case, similarly to the embodiments described above, the light emitting elements 500 respectively perform the illuminating processes on corresponding blocks.

Also, in the third embodiment, the adjustment method of the strobe periods and strobe intervals described in the first embodiment and the second embodiment can be adopted.

<Other>

Although the number of groups set by the image writing control unit 433 is described as four, the number of groups may be arbitrarily set.

Also, allocation of the light emitting elements 500 to respective groups described above is not a limiting example. The light emitting elements 500 randomly selected may constitute the respective groups, or the light emitting elements 500 for performing the illuminating process on successive blocks may be selected to constitute the respective groups. The image writing control unit 433 may adjust the strobe periods the respective groups so that average light intensities of the light emitting elements 500 in the respective groups become closer to each other, where the respective groups have defined in advance so that the average of the light intensities of the respective groups become as even as possible.

For example, the image forming apparatus 100 of the embodiments described above is a MFP (Multifunction Peripheral), a printer and a FAX.

A recording medium storing program codes of software for achieving respective functions of the above described embodiments may be provided to the image forming apparatus 100. The image forming apparatus 100 retrieves the program codes stored in the recording medium to execute them, thereby achieving the respective functions of the embodiments. In this case, the program codes retrieved from the recording medium achieve the functions of the embodiments, and the recording medium storing the program codes corresponds to any one of the embodiments. Here, the recording medium is a storage medium or a non-temporal recording medium.

Also, the executed program codes may achieve functions other than the functions of the described embodiments or a part of the functions of the described embodiments. An operating system (OS) executed in a computer may perform a part or all of actual processes in accordance the program codes. Further, the functions of the embodiments may be achieved by the actual processes.

Herein above, although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth. The present application is based on Japanese Priority Application No. 2015-123235 filed on Jun. 18, 2015, the entire contents of which are hereby incorporated herein by reference.

What is claimed is:

1. An image forming apparatus for forming a latent image on a photoconductor by causing a plurality of light emitting bodies to emit light, the image forming apparatus comprising:
a storage unit configured to store respective performances of the light emitting bodies;
a control unit configured to control the light emitting bodies to emit the light; wherein
the control unit adjusts light emitting periods of the light emitting bodies based on the performances of the light emitting bodies so that a capability of one light emitting body of the light emitting bodies for forming the latent image becomes closer to a capability of another light emitting body of the light emitting bodies for forming the latent image.

2. The image forming apparatus according to claim 1, wherein
the light emitting bodies respectively include a plurality of light emitting elements, and
light emitting elements respectively form the latent image on predetermined areas of the photoconductor.

3. The image forming apparatus according to claim 1, wherein the capability for forming the latent image corresponds to light energy received by the photoconductor, and the performances of the light emitting bodies corresponds to light intensities of the light emitting bodies.

4. The image forming apparatus according to claim 2, wherein
the capability for forming the latent image corresponds to a value calculated by multiplying an area of spot by a light emitting period corresponding to a light emitting body of the light emitting bodies, the spot being formed by a light emitting element included in the light emitting body, and wherein
the performances of the light emitting bodies corresponds to the area of the spot.

5. The image forming apparatus according to claim 1, wherein the light emitting periods are adjusted so that the capability of one light emitting body becomes closer to an average of capabilities of all light emitting bodies.

6. The image forming apparatus according to claim 1, further comprising
a plurality of photoconductors provided on a toner color-by-toner color basis, wherein
a plurality of the light emitting bodies are provided with respect to each of the photoconductors and the control unit controls the light emitting bodies to emit the light on the photoconductors to form latent images on the respective photoconductors,
a light emitting interval is set between a light emitting period of the one light emitting body and a light emitting period of the other light emitting body, and
the control unit adjusts the light emitting period and the light emitting interval so that a light emitting cycle does not vary before and after the adjustment in forming the latent image on the respective photoconductors, the light emitting cycle being a sum of one light emitting period and one light emitting interval.

7. The image forming apparatus according to claim 1, wherein
the storage unit stores a shortest settable light emitting interval, the light emitting interval being set between the light emitting period of the one light emitting body and the light emitting period of the other light emitting body, and wherein
the control unit controls the other light emitting body to emit the light upon the shortest settable light emitting interval passing after the light emitting period of the one light emitting body finishes.

8. The image forming apparatus according to claim 1, wherein the storage unit sores a shortest settable light emitting period of the one light emitting body, and
in a case where the light emitting period of the one light emitting body is set to be the shortest settable light emitting period, the control unit adjusts the light emitting period of the other light emitting body so that the capability of the one light emitting body of the light emitting bodies for forming the latent image becomes closer to the capability of the other light emitting body of the light emitting bodies for forming the latent image.

9. The image forming apparatus according to claim 1, wherein the storage unit sores a longest settable light emitting period of the one light emitting body, and
in a case where the light emitting period of the one light emitting body is set to be the longest settable light emitting period, the control unit adjusts the light emitting period of the other light emitting body so that the capability of the one light emitting body of the light emitting bodies for forming the latent image becomes closer to the capability of the other light emitting body of the light emitting bodies for forming the latent image.

10. A non-transitory computer-readable recording medium having stored therein a program for causing a computer to perform an image forming method, in which a plurality of light emitting bodies emit the light to form a latent image on a photoconductor, the image forming method comprising:
storing respective performances of the light emitting bodies;
controlling the light emitting bodies to emit the light; wherein
in controlling the light emitting bodies, light emitting periods of the light emitting bodies are adjusted based on the performances of the light emitting bodies so that a capability of one light emitting body of the light emitting bodies for forming the latent image becomes closer to a capability of another light emitting body of the light emitting bodies for forming the latent image.
